(19) United States
(12) Patent Application Publication
(10) Pub. No.: US 2012/0127755 A1
(43) Pub. Date: May 24, 2012

(54) LIGHT GUIDE PLATE AND BACKLIGHT MODULE

(75) Inventors: Tzeng-Ke Shiau, Hsin-Chu (TW); Chen-Kun Liu, Hsin-Chu (TW)

(73) Assignee: CORETRONIC CORPORATION, Hsin-Chu (TW)

(21) Appl. No.: 13/297,281

(22) Filed: Nov. 16, 2011

(30) Foreign Application Priority Data
Nov. 22, 2010 (TW) 99140199

(51) Int. Cl. F21V 8/00

(52) U.S. Cl. 362/607

(57) ABSTRACT

A light guide plate is adapted for guiding a light beam provided by a light emitting device. The light guide plate includes a light-transmissive substrate, a plurality of optical microstructures, and a plurality of diffusion particles. The light-transmissive substrate has a first surface, a second surface, and a light incident surface. The second surface is opposite to the first surface. The light incident surface connects the first surface and the second surface. The light beam is capable of entering the light-transmissive substrate through the light incident surface. The optical microstructures are disposed on the second surface. The diffusion particles are distributed in the light-transmissive substrate, and a haze value of the light guide plate is greater than or equal to 0.4% and smaller than or equal to 80%. A backlight module using the light guide plate is also provided.

### CROSS-REFERENCE TO RELATED APPLICATION

This application claims the priority benefit of Taiwan application serial no. 99140199, filed on Nov. 22, 2010. The entirety of the above-mentioned patent application is hereby incorporated by reference herein and made a part of this specification.

### BACKGROUND OF THE INVENTION

1. Field of the Invention

The disclosure is related to an optical device and a light source module, and in particular to a light guide plate and a backlight module.

2. Description of Related Art

A backlight module generally includes a light guide plate, and the light guide plate is used to guide a scattering direction of a light beam provided by a light source, so as to increase luminance of a panel and ensure uniformity of brightness of the panel, thereby converting a point light source or a linear light source into a planar light source to be supplied to a liquid crystal display panel. In detail, when the light beam enters the light guide panel, since a main body of the light guide panel is light-transmissive, no refraction or scattering of the light beam occurs, so that the light beam follows a conventional total internal reflection manner and is transmitted to outside the light guide plate, or total internal reflection is disrupted by microstructures on a surface of the light guide plate and refraction occurs, so that the light beam is transmitted to outside the light guide plate.

Generally, by adjusting a density of the microstructures, an amount of emitted light is able to be controlled, thereby controlling the luminance and uniformity of emitted light of the light guide plate. The microstructures may be fabricated by ink jetting, printing, or etching. General nozzles of an ink jet head are arranged in an array, so that a greatest density obtained by ink jetting cannot be compared with that obtained by other fabrication processes. When using ink jetting to fabricate the microstructures, if ink droplets are too close to each other before hardening, adjacent ink droplets are easily connected to each other, thereby causing structural flaws. In addition, since the ink jet droplets have regular protruding ball shapes, are highly uniform, and lack scattering abilities and sufficient light emission abilities, the flaws of the light guide plates cannot achieve hazing effects through partial scattering.

FIG. 1 is a schematic diagram of a conventional backlight module. Please refer to FIG. 1. A conventional backlight module 100 includes a light emitting device 110, a light guide plate 120, and a reflective unit 130. The light emitting device 110 is capable of emitting a light beam L1. The light guide plate 120 is disposed adjacent to the light emitting device 110 and is capable of guiding the light beam L1. The light guide plate 120 includes a light-transmissive substrate 122 and a plurality of optical microstructures 124.

As shown in FIG. 1, when the light beam L1 shines on the optical microstructures 124 on a surface S2 of the light guide plate 120, the optical microstructures 124 disrupt total internal reflection by the light guide plate 120, so that the light beam L1 passes through a surface S1 of the light guide plate 120 and is transmitted to outside the backlight module 100. However, another light beam L2 emitted by the light emitting device 110 is directly transmitted to a surface S4 of the light guide plate 120, and is barely reflected inside the light-transmissive substrate 122. Therefore, in the conventional backlight module 100, the light beams that are transmitted to outside the light-transmissive substrate 122 are reduced in number, so that overall light emission abilities of the backlight module 100 is insufficient.

Taiwan Patent No. 1287135 and Taiwan Patent Application Publication No. 200732785 each discloses technologies for fabricating microstructures on light guide plates by ink jetting. On the other hand, Taiwan Patent No. M314346 and M299866, U.S. Patent Application Publication No. 20030210222, China Patent Application Publication No. 101078836 and China Patent No. 1260583 also disclose several structures related to light guide plates.

### SUMMARY OF THE INVENTION

The disclosure provides a light guide plate which has good light usage efficiency.

The disclosure provides a backlight module which provides a planar light source which is more uniform.

Other objects and advantages of the disclosure may be further understood from the technical features disclosed in the disclosure.

In order to achieve one, a part, or all of the above objectives or other objectives, an embodiment of the disclosure provides a light guide plate. The light guide plate is adapted for guiding a light beam emitted by a light emitting device. The light guide plate includes a light-transmissive substrate, a plurality of optical microstructures, and a plurality of diffusion particles. The light-transmissive substrate includes a first surface, a second surface, and a light incident surface. The second surface is opposite to the first surface. The light incident surface connects the first surface and the second surface, wherein the light beam is capable of entering the light-transmissive substrate through the light incident surface. The optical microstructures are disposed on the second surface. The diffusion particles are distributed in the light-transmissive substrate, and a haze value of the light guide plate is greater than or equal to 0.4% and smaller than or equal to 80%.

Another embodiment of the disclosure further provides a backlight module which includes a first light emitting device and a light guide plate. The first light emitting device is capable of emitting a light beam. The light guide plate is disposed adjacent to the first light emitting device and is capable of guiding the light beam. The light guide plate includes a light-transmissive substrate, the above-described optical microstructures, and the above-described diffusion particles. The light-transmissive substrate includes the above-described first surface, the above-described second surface, and a first light incident surface connecting the first surface and the second surface. The light beam is capable of entering the light-transmissive substrate through the first light incident surface.

Due to the above, the embodiments of the disclosure achieve at least one of the following advantages or effects. The light guide plate according to the embodiments of the disclosure adopts the diffusing particles to effectively scatter the light beam, so as to enhance the light usage efficiency of the light guide plate. Therefore, the backlight module which adopts the light guide plate provides a planar light source which is more uniform.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a conventional backlight module.

FIG. 2 is a schematic diagram of a backlight module according to the first embodiment of the disclosure.

FIG. 3A is a schematic diagram showing distribution light emitted from a light guide plate in FIG. 2 at different angles.

FIG. 3B is a schematic diagram showing distributions of light emitted from the light guide plate in FIG. 2 at different positions.

FIG. 4 is a schematic diagram of a backlight module according to the second embodiment of the disclosure.

FIG. 5 is a schematic diagram of a backlight module according to the third embodiment of the disclosure.

FIG. 6 is a schematic diagram of a backlight module according to the fourth embodiment of the disclosure.

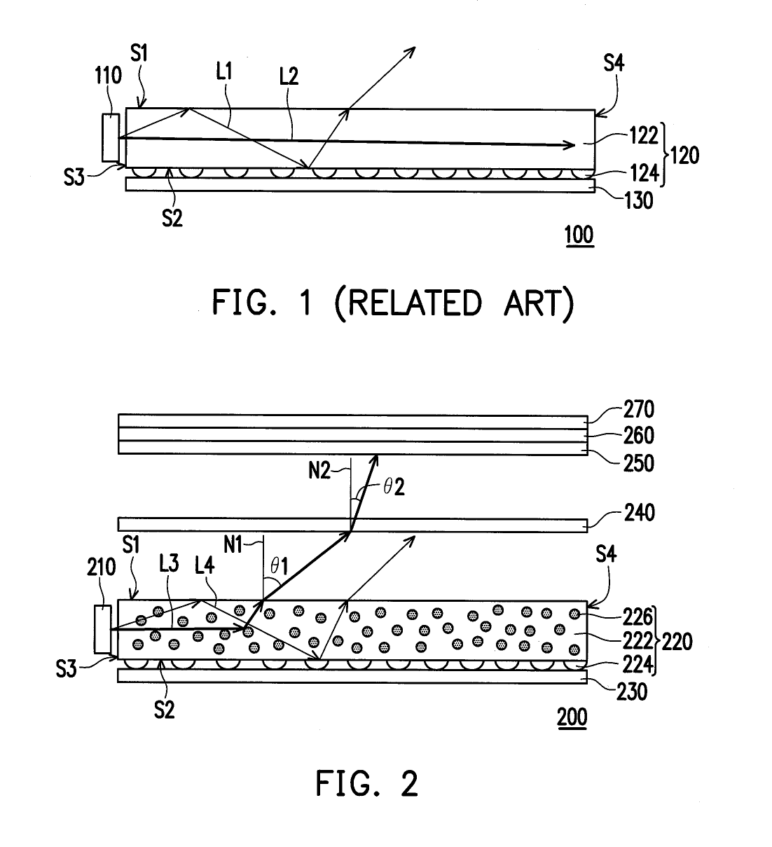

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to.” Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

FIG. 2 is a schematic diagram of a backlight module according to the first embodiment of the disclosure. Please refer to FIG. 2. A backlight module 200 according to the present embodiment includes a light emitting device 210 and a light guide plate 220. The light emitting device 210 is capable of emitting a light beam L3. The light guide plate 220 is disposed adjacent to the light emitting device 210 and is capable of guiding the light beam L3. According to the present embodiment, the light emitting device 210 is, for example, a light emitting diode (LED). The light guide plate 220 includes a light-transmissive substrate 222, a plurality of optical microstructures 224, and a plurality of diffusion particles 226.

The light-transmissive substrate 222 includes a surface S1, a surface S2 opposite to the surface S1, a light incident surface S3 connecting the surface S1 and the surface S2, and a surface S4 opposite to the light incident surface S3, wherein the light beam L3 is capable of entering the light-transmissive substrate 222 through the light incident surface S3. The light-transmissive substrate 222 is, for example, a flat substrate. The optical microstructures 224 are disposed on the surface S2. The diffusion particles 226 are distributed in the light-transmissive substrate 222, wherein a size of the diffusion particles 226 is greater than or equal to 100 nm and smaller than or equal to 30 μm. A haze value of the light guide plate 220 is greater than or equal to 0.4% and smaller than or equal to 80%. The haze value of the light guide plate 220 is measured by a haze meter from the NIPPON DENSHOKU company (model number NDH 5000). Generally, the higher the haze value, the greater the scattering ability of the light guide plate 220, thereby a greater concealing ability is achieved for the light guide plate 220. The diffusion particles 226 enhance the scattering ability of the light guide plate 220 and reduce the transparency of the light guide plate 220, so as to make the flaws less apparent. The flaws are, for example, scratches on the light-transmissive substrate 222 caused by manufacturing processes or other factors, so that the scratches on the surface S1 of the light-transmissive substrate 222 or lines of the optical microstructures 224 are visible. Moreover, measurement of the haze value is performed, for example, at a direction from the surface S1 towards the surface S2 of the light-transmissive substrate 222, or at a direction from the surface S2 towards the surface S1 of the light-transmissive substrate 222.

According to the present embodiment, the optical microstructures 224 are fabricated on the surface S2 by ink jetting, so as to generate the tiny optical microstructures 224, thereby facilitating reduction of the thickness of the backlight module 200. Furthermore, during the process of fabricating the optical microstructures 224 by ink jetting, by moving the ink jet head or the light-transmissive substrate 222, the optical microstructures 224 which have different sizes or different distances in between are able to be fabricated on the light-transmissive substrate 222. As shown in FIG. 2, the optical microstructures 224 are arranged as having non-uniform distances in between. In detail, according to the present embodiment, a numerical density of the optical microstructures 224 near the light emitting device 210 is less than a numerical density of the optical microstructures 224 away from the light emitting device 210. Generally, nozzles of the ink jet head are arranged in an array, and a distance between one nozzle and another nozzle is fixed. If the optical microstructures 224 which have non-uniform densities are to be formed, the optical microstructures 224 are formed by controlling ink jetting from the ink jet head. For example, when the ink jet head moves to near the light emitting device 210 on the surface S2, the nozzles of the ink jet head may be controlled to stop ink jetting every few interval points, so as to form the optical microstructures 224 which have a lower density on the surface S2. On the contrary, when the ink jet head moves away from the light emitting device 210 on the surface S2, the nozzles of the ink jet head may be controlled to jet ink at every interval point, so as to form the optical microstructures 224 which have a higher density on the surface S2. Additionally, the optical microstructures 224 are, for example, protruding dots, and a size of the protruding dots is controlled by adjusting a number of ink droplets.

Moreover, the haze value of the light guide plate 220 near the light emitting device 210 is greater than or equal to 0.4% and smaller than or equal to 30%, and the haze value of the light guide plate 220 away from the light emitting device 210 is greater than or equal to 12% and smaller than or equal to 80%. Since according to the present embodiment, the range of the haze value of the light guide plate 220 near the light emitting device 210 is different from the range of the haze value of the light guide plate 220 away from the light emitting device 210, a uniform planar light source is provided.

Furthermore, the backlight module 200 according to the present embodiment further includes a reflective unit 230. The reflective unit 230 is disposed on the a side of the surface S2 of the light-transmissive substrate 222, and the optical microstructures 224 are located between the surface S2 and the reflective unit 230. The reflective unit 230 is, for example, a reflective sheet or a reflective film, and the reflective sheet is, for example, a white reflective sheet or a silver reflective sheet. The reflective unit 230 is capable of increasing luminance of the backlight module 200.

As shown in FIG. 2, the light beam L4 emitted by the light emitting device 210 is total internal reflected for multiple times in the light-transmissive substrate 222 and is emitted out of the light-transmissive substrate 222 through the surface S1. The surface S1 is, for example, a light emitting surface. When the light beam L4 shines on the optical microstructures 224 on the surface S2, the optical microstructures 224 disrupt the total internal reflection, so that the light beam L4 passes through the surface S1 and is transmitted to outside the backlight module 200.

It should be noted that since the diffusion particles 226 are added into the light-transmissive substrate 222, a transmission path of the light beam L3 is changed due to its interaction with the diffusion particles 226, so that the light beam L3 is directly transmitted to outside the light-transmissive substrate 222 through the surface S1. Therefore, through the addition of the diffusion particles 226, the light beam L3 is emitted from the surface S1 of the light-transmissive substrate 222 earlier, thereby increasing the luminance of the backlight module 200. In other words, although the optical microstructures 224 according to the present embodiment are fabricated by ink jet dot distribution, the light guide plate 220 does not have problems of insufficient overall luminance due to insufficient dot density of the optical microstructures 224. In addition, light beams of different polarization (such as the light beam L3) are scattered by the diffusion particles 226, the concealing ability of the light guide plate 220 become better. According to the present embodiment, the diffusion particles 226 are, for example, silicon dioxide (SiO₂), titanium dioxide (TiO₂), or resins having different refractive indexes. In short, the addition of the diffusion particles 226 facilitates scattering of the light beams (such as the light beam L3), thereby increasing the uniformity and luminance of the emitted light.

Furthermore, the backlight module 200 according to the present embodiment further includes an optical film 240, wherein the optical film 240 is, for example, a lower diffusion sheet. In addition, the backlight module 200 may further include optical films 250, 260, and 270, and the optical films 250, 260, and 270 are respectively a lower prism sheet, an upper prism sheet, and a dual brightness enhancement film (DBEF). As shown in FIG. 2, after the light beam L3 is scattered by the diffusion particles 226, a light emission angle θ1 when the light beam L3 is emitted from the surface S1 of the light guide plate 220 is, for example, from 55 degrees to 75 degrees. With this range of the light emission angle θ1 and cooperation with other optical films, effects of one-time light emission of the light beam L3 is achieved, thereby generating better luminance and uniformity. According to the present embodiment, the angle θ1 is an included angle between the light beam L3 emitted from the surface S1 of the light guide plate 220 after the light beam L3 is scattered by the diffusion particles 226 and a normal direction N1 of the light guide plate 220. In detail, after the light beam L3 which has passed through the light-transmissive substrate 222 including the diffusion particles 226 further passes through the optical film 240, the light beam L3 is emitted at a smaller angle θ2, thereby increasing the overall luminance of the backlight module 200. According to the present embodiment, the angle θ2 is an included angle between the light beam L3 emitted from the optical film 240 and a normal direction N2 of the optical film 240. The angle θ2 is, for example, from 15 degrees to 45 degrees. However, the disclosure is not limited to this configuration. In short, according to the present embodiment, by using the light-transmissive substrate 222 including the diffusion particles 226, the overall luminance and uniformity of the backlight module 200 is increased.

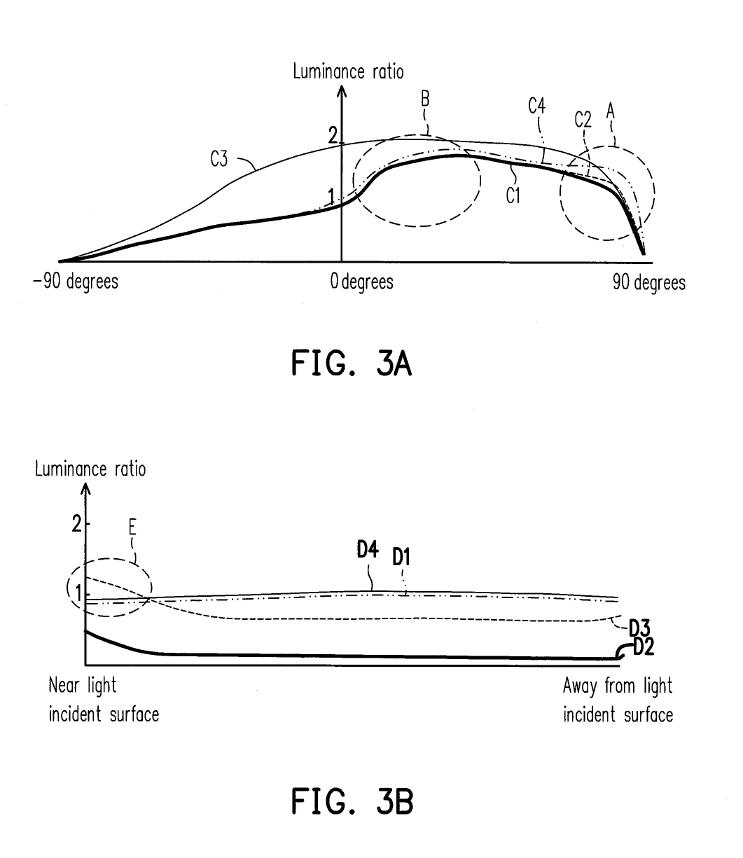

FIG. 3A is a schematic diagram showing distributions light emitted from the light guide plate 220 in FIG. 2 at different angles, wherein the vertical axis and horizontal axis of FIG. 3A are respectively the luminance ratio and angle of the emitted light, and −90 degrees to 90 degrees are the viewing angles of the surface S1 of the light guide plate 220. In detail, according to the present embodiment, the normal direction N1 of the surface S1 is defined as 0 degree, a direction parallel to the surface S1 and pointing towards the light emitting device 210 is defined as −90 degrees, and a direction parallel to the surface S1 and pointing away from the light emitting device 210 is defined as 90 degrees. Moreover, a measuring point for the angle of the emitted light is the surface S1 of the light guide plate 220 near the light emitting device 210, the center of the surface S1 of the light guide plate 220, and the surface S1 of the light guide plate 220 away from the light emitting device 210.

In FIG. 3A, a curve C1 represents the distribution of the angles of the emitted light when none of the diffusion particles 226 are added into the light-transmissive substrate 222, and curves C2-C4 represent the distribution of the angles of the emitted light when the light-transmissive substrate 222 includes the diffusion particles 226. In detail, the curve C2 corresponds to a distribution of the emitted light wherein the haze value of the light guide plate 220 near the light emitting device 210 is less than 0.4% and the haze value of the light guide plate 220 away from the light emitting device 210 is less than 12%. The curve C3 corresponds to a distribution of the emitted light wherein the haze value of the light guide plate 220 near the light emitting device 210 is greater than 30% and the haze value of the light guide plate 220 away from the light emitting device 210 is greater than 80%. In addition, the curve C4 corresponds to a distribution of the emitted light wherein the haze value of the light guide plate 220 near the light emitting device 210 is greater than or equal to 0.4% and smaller than or equal to 30% and the haze value of the light guide plate 220 away from the light emitting device 210 is greater than or equal to 12% and smaller than or equal to 80%.

As shown in FIG. 3A, in an area A, luminance ratios of the curves C2, C4, and C3 are all higher than a luminance ratio of the curve C1, where an angle of emitted light that corresponds to the curve C4 in the area A is, for example, the angle θ1 of the emitted light in FIG. 2, and a range thereof is from 55 degrees to 75 degrees. Furthermore, through the addition of the diffusion particles 226, the haze value of the light guide plate 220 near the light emitting device 210 is greater than or equal to 0.4% and smaller than or equal to 30%, and the haze value of the light guide plate 220 away from the light emitting device 210 is greater than or equal to 12% and smaller than or equal to 80%, so that a greater portion of the light beam L3 is emitted from the light guide plate 220 at angles from 55 degrees to 75 degrees. As described above, effects of one-time light emission are generate by utilizing this range of angles in conjunction with other optical films, so that the overall luminance and uniformity of the backlight module 200 is increased. Moreover, in an area B, the curve C4 is smoother than the curves C1 and C2.

However, it should be noted that as shown by the curve C3, when an excess of the diffusion particles 226 is added to the light-transmissive substrate 222, the haze value of the light guide plate 220 near the light emitting device 210 greater than 30%, and the haze value of the light guide plate 220 away from the light emitting device 210 is greater than 80%, so that a excessive portion of the light beam is emitted from the light guide plate 220 at angles from −90 degrees to 0 degree. Since the above range of angles of light emission (−90 to 0) is not beneficial to one-time light emission through cooperation with other optical films, light usage efficiency could not be effectively increased. Therefore, it is shown from the above that it is preferable that the haze value of the light guide plate 220 is greater than or equal to 0.4% and smaller than or equal to 80% (corresponding to the curve C4).

FIG. 3B is a schematic diagram showing distributions of light emitted from the light guide plate 220 in FIG. 2, wherein the horizontal axis corresponds to a position of the light guide plate 220 near the light emitting device 210 to a position of the light guide plate 220 away from the light emitting device 210, meaning that the horizontal axis corresponds to a position of the light guide plate 220 near the light incident surface S3 to a position of the light guide plate 220 away from the light incident surface S3. The vertical axis represents luminance ratios at these positions. In FIG. 3B, a curve D1 represents a distribution of emitted light when the light guide plate 220 includes the optical microstructures 224 but not the diffusion particles 226. Curves D2 and D3 represents distributions of emitted light when the light guide plate 220 includes the diffusion particles 226 but not the optical microstructures 224. A curve D4 represents a distribution of emitted light when the light guide plate 220 includes the diffusion particles 226 and the optical microstructures 224. As clearly shown in FIG. 3B, a luminance ratio of the curve D4 is greater than luminance ratios of the curves D1, D2, and D3. In other words, the light guide plate 220 which includes the diffusion particles 226 and the optical microstructures 224 facilitates increase of luminance.

In addition, the curve D2 corresponds to a distribution of the emitted light when the haze value of the light guide plate 220 is less than 0.4%, and the curve D3 corresponds to a distribution of the emitted light when the haze value of the light guide plate 220 is greater than 30%. As shown by the curves D2 and D3, with an increase in a concentration of the diffusion particles 226, the overall luminance ratio of the light guide plate 220 also increases. However, it should be noted that as shown in the curve D3, when the haze value of the light guide plate 220 is greater than 30%, the luminance ratio in an area E corresponding to the light guide plate 220 near the light incident surface S3 is higher than luminance ratios of the light guide plate 220 at other positions. Therefore, under the circumstance that the light guide plate 220 includes the diffusion particles 226 but not the optical microstructures 224, when the haze value of the light guide plate 220 is greater than 30%, halo effects occur at the light guide plate 220 near the light incident surface S3.

As shown in FIGS. 3A and 3B, the backlight module 200 according to the embodiment in FIG. 2 provides a planar light source that is more uniform and has greater luminance due to the addition of the diffusion particles 226. According to the present embodiment, when the haze value is less than 0.4%, problems of insufficient luminance of the light guide plate 220 occur, and when the haze value is greater than 80%, halo effects occur at the light guide plate 220 near the light incident surface S3. Therefore, when the light guide plate 220 includes the diffusion particles 226 and the optical microstructures 224 so that the haze value of the light guide plate 220 is greater than or equal to 0.4% and smaller than or equal to 80%, the backlight module 200 provides a planar light source that is more uniform and has greater luminance.

### Second Embodiment

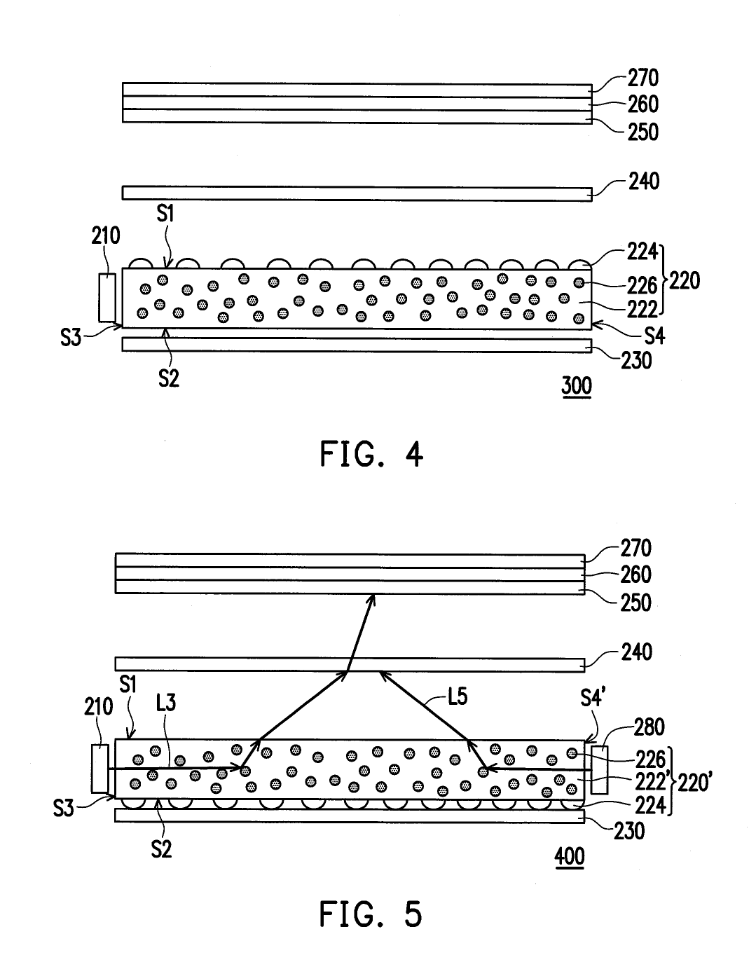

FIG. 4 is a schematic diagram of a backlight module according to the second embodiment of the disclosure. As shown in FIG. 4, a backlight module 300 is similar to the backlight module 200 in FIG. 2. A main difference in between is that the optical microstructures 224 of the backlight module 300 are disposed on the surface S1. Sufficient teaching, suggestion, and implementation of the backlight module 300 may be found in the description of the embodiment shown in FIGS. 2-3B and are hence not repeatedly described.

### Third Embodiment

FIG. 5 is a schematic diagram of a backlight module according to the third embodiment of the disclosure. As shown in FIG. 5, a backlight module 400 is similar to the backlight module 200 in FIG. 2. A main difference in between is that the backlight module 400 further includes a light emitting device 280, and a light-transmissive substrate 222′ further includes a light incident surface S4′ opposite to the light incident surface S3, wherein the light emitting device 280 is disposed adjacent to the light incident surface S4′.

As shown in FIG. 5, the light emitting device 280 is capable of emitting a light beam L5, and since the diffusion particles 226 are added into the light-transmissive substrate 222′, a transmission path of the light beam L5 is changed due to its interaction with the diffusion particles 226, so that the light beam L5 is directly transmitted to outside the light-transmissive substrate 222′ through the surface S1. Therefore, through the addition of the diffusion particles 226, the light beam L5 is emitted from the surface S1 of the light-transmissive substrate 222′ earlier, thereby increasing luminance of the backlight module 400. Sufficient teaching, suggestion, and implementation of the backlight module 400 may be found in the description of the embodiment shown in FIGS. 2-3B and are hence not repeatedly described.

### Fourth Embodiment

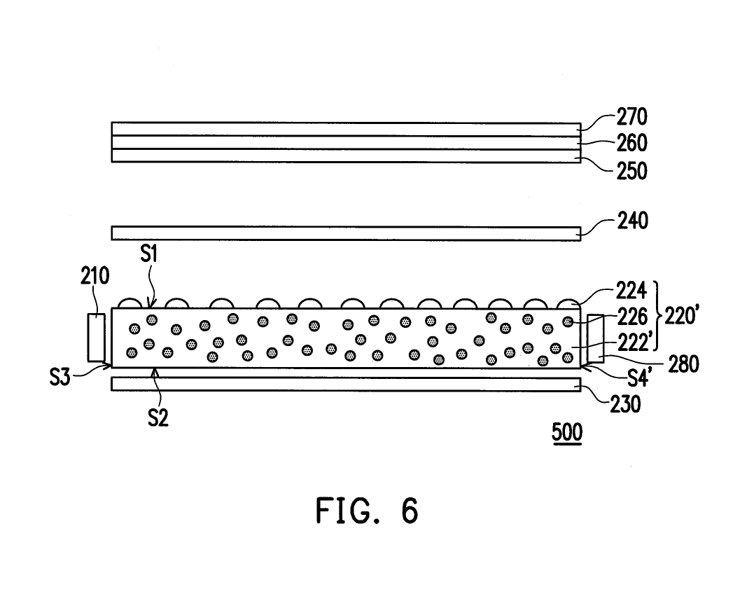

FIG. 6 is a schematic diagram of a backlight module according to the fourth embodiment of the disclosure. As shown in FIG. 6, a backlight module 500 is similar to the backlight module 400 in FIG. 5. A main difference in between is that the optical microstructures 224 of the backlight module 500 are disposed on the surface S1. Sufficient teaching, suggestion, and implementation of the backlight module 500 may be found in the description of the embodiment shown in FIGS. 2-3B and FIG. 5 and are hence not repeatedly described.

In summary, the embodiments of the disclosure achieve at least one of the following advantages or effects. The light guide plate according to the embodiments of the disclosure utilizes the diffusion particles to change the transmission path of the light beam from the light incident surface of the light guide plate, so that the light beam is effectively scattered, thereby enhancing the light usage efficiency of the light guide plate. Hence, the backlight module which adopts this light guide plate provides a planar light source that is more uniform and has greater luminance. Moreover, the haze value of the light guide plate is greater than or equal to 0.4% and smaller than or equal to 80%, so that the light guide plate has good concealing effects.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention,” “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first,” “second,” etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A light guide plate, adapted for guiding a light beam emitted by a light emitting device, the light guide plate comprising:
a light-transmissive substrate, comprising:
a first surface;
a second surface, opposite to the first surface; and
a light incident surface, connecting the first surface and the second surface, wherein the light beam is capable of entering the light-transmissive substrate through the light incident surface;
a plurality of optical microstructures, disposed on the second surface; and
a plurality of diffusion particles, distributed in the light-transmissive substrate, and a haze value of the light guide plate is greater than or equal to 0.4% and smaller than or equal to 80%.

2. The light guide plate as claimed in claim 1, wherein the optical microstructures are fabricated on the second surface by ink jetting.

3. The light guide plate as claimed in claim 1, wherein a numerical density of the optical microstructures near the light emitting device is less than a numerical density of the optical microstructures away from the light emitting device.

4. The light guide plate as claimed in claim 3, wherein the haze value of the light guide plate near the light emitting device is greater than or equal to 0.4% and smaller than or equal to 30%, and the haze value of the light guide plate away from the light emitting device is greater than or equal to 12% and smaller than or equal to 80%.

5. The light guide plate as claimed in claim 1, wherein the light beam is capable of being transmitted out of the light-transmissive substrate through the first surface.

6. The light guide plate as claimed in claim 1, wherein the light-transmissive substrate is a flat substrate.

7. A backlight module, comprising:
a first light emitting device, capable of emitting a light beam; and
a light guide plate, disposed adjacent to the first light emitting device and capable of guiding the light beam, the light guide plate comprising:
a light-transmissive substrate, comprising a first surface, a second surface opposite to the first surface, and a first light incident surface connecting the first surface and the second surface, wherein the light beam is capable of entering the light-transmissive substrate through the first light incident surface;
a plurality of optical microstructures, disposed on the second surface; and
a plurality of diffusion particles, distributed in the light-transmissive substrate, and a haze value of the light guide plate is greater than or equal to 0.4% and smaller than or equal to 80%.

8. The backlight module as claimed in claim 7, wherein the optical microstructures are fabricated on the second surface by ink jetting.

9. The backlight module as claimed in claim 7, wherein a numerical density of the optical microstructures near the first light emitting device is less than a numerical density of the optical microstructures away from the first light emitting device.

10. The backlight module as claimed in claim 9, wherein the haze value of the light guide plate near the first light emitting device is greater than or equal to 0.4% and smaller than or equal to 30%, and the haze value of the light guide plate away from the first light emitting device is greater than or equal to 12% and smaller than or equal to 80%.

11. The backlight module as claimed in claim 7, wherein the light beam is capable of being transmitted out of the light-transmissive substrate through the first surface.

12. The backlight module as claimed in claim 11, further comprising a reflective unit, disposed on a side of the second surface of the light-transmissive substrate, and the optical microstructures being disposed between the second surface and the reflective unit.

13. The backlight module as claimed in claim 7, wherein the light-transmissive substrate is a flat substrate.

14. The backlight module as claimed in claim 7, further comprising a second light emitting device, and the light-transmissive substrate further comprising a second light incident surface opposite to the first light incident surface, wherein the second light emitting device is disposed adjacent to the second light incident surface.

15. The backlight module as claimed in claim 7, further comprising at least one optical film.
